(19) United States
(12) Patent Application Publication
(10) Pub. No.: US 2011/0027038 A1
(43) Pub. Date: Feb. 3, 2011

(54) HEAT SINK ANCHORING APPARATUS

(75) Inventors: Ying-Lin HSU, Shen Tsun City (CN); Yu-Cheng LIN, Shen Tsun City (CN); Pen-Chun YU, Shen Tsun City (CN)

Correspondence Address: Ching-Ling Huang, 5597 NW 127th Ter, Portland, OR, 97229, US

(73) Assignee: Pen-Chun YU, Shen Tsun City (CN)

(21) Appl. No.: 12/510,285

(22) Filed: Jul. 28, 2009

(51) Int. Cl. F16B 39/00

(52) U.S. Cl. 411/105

(57) ABSTRACT

A heat sink anchoring apparatus includes a bushing, an elastic element and an insertion rod. The bushing has a position end and a sleeve. The position end is latched on the baseboard to hold the bushing on the baseboard in an upright manner. The sleeve has an axle hole extended towards the position end and at least one track with a retaining notch formed on the inner edge of the axle hole. The elastic element and the anchoring leg are coupled on the sleeve at the outer edge. The insertion rod has at least one sliding portion to enter the track and a force applying portion at the other end. The force applying portion is compressible to compress the elastic element to form a retaining elastic force on the anchoring leg. The sliding portion is movable along the track and latchable on the retaining notch for positioning.

### FIELD OF THE INVENTION

The present invention relates to a heat sink anchoring apparatus and particularly to an anchoring fixture to provide fast fastening and disassembling of a heat sink with adjustable applying pressure.

### BACKGROUND OF THE INVENTION

A circuit usually generates heat during operation. The waste heat accumulates and could result in overheat and impair circuit operation or damage circuit elements. This is especially true in the computational circuits of computers that performs high speed operations. Hence computer processor (CPU, or even including south and north bridge chips, or graphic processing chip) usually is equipped with a heat sink to provide cooling. Conventional anchoring heat sink generally is anchored through screws, latch tenon and latch clips. Reference of screw fastening can be found in R.O.C. patent No. 1303550 entitled “Heat sink latch apparatus” which screws a screwing element (screw) and a nut at two opposite sides of a baseboard. The screwing element and the nut are further interposed by an axle seat and a seal element. It provides some improvements over the conventional screw and nut, but is still confined in the concept of the conventional screw and nut fastening.

Reference of the conventional technique adopted the latch tenon can be found in R.O.C. patent No. M350744 entitled “Heat sink latch structure (2)”. It has an insertion rod, elastic element, sleeve and a supporting pedestal mating a notch formed on the sleeve to form latch coupling between them. The supporting pedestal is anchored and the elastic element provides an anchoring force. The sleeve has a tenon-type hook at the lower end latching on an aperture formed on a baseboard to anchor the whole heat sink onto the baseboard. However, its structure is complicated, and difficult to assemble and disassemble. Production cost also is higher.

R.O.C. patent No. 481300 entitled “Heat sink latch device” provides a latch device which has a butting portion with two ends extended to form a first elastic arm and a second elastic arm. The first elastic arm and second elastic arm are bent downwards to form a first latch clip and a second latch chip. The latch device is latched on a sliding portion of a slot connector and depressed to be anchored on a set of heat sinks. While it provides a firmer positioning, a space has to be reserved above the heat sinks to allow the latch chip to pass through. The applicability of such heat sinks is limited.

All the heat sink anchoring apparatus mentioned above have their share of advantages and drawbacks. They all have difficulty to meet the end of fast anchoring, disassembling, simple structure and no restriction of heat sink types. The contemporary processor specifications demand heat sinks to withstand specific compression forces (by pounds). The conventional anchoring apparatus have difficulty to adjust the compression force. All these show that there are still rooms for improvements.

### SUMMARY OF THE INVENTION

In view of the drawbacks of the conventional latch devices, the primary object of the present invention is to provide a novel heat sink latch device that can adjust compression force and allow fast anchoring and disassembling with a simpler structure.

The present invention provides a heat sink anchoring apparatus to anchor a heat sink equipped with an anchoring leg on a baseboard. The anchoring apparatus includes a bushing, an elastic element and an insertion rod. The bushing has a position end and a sleeve. The position end is latched on the baseboard to allow the bushing to stand upright on the baseboard. The sleeve has an axle hole extended towards the position end, and at least one track formed on the inner edge of the axle hole with at least one retaining notch. The elastic element and the anchoring leg are coaxially coupled outside the sleeve. The insertion rod has at least one sliding portion to enter the track and a force applying portion at the other end of the insertion rod to compress the elastic element to form a retaining elastic force pressing the anchoring leg and allow the sliding portion to move along the track to the retaining notch to be latched for positioning. Thus the anchoring leg can be firmly positioned on the baseboard. Anchoring and disassembling of the anchoring leg of the heat sink can be accomplished quickly and easily.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the anchoring apparatus of the invention.

FIG. 2 is a perspective view of the bushing.

FIG. 3 is a schematic view of the insertion rod and the bushing in a coupling condition.

FIG. 4A is a schematic view of the insertion rod and the bushing coupled in operating condition-1.

FIG. 4B is a schematic view of the insertion rod and the bushing coupled in operating condition-2.

FIG. 4C is a schematic view of the insertion rod and the bushing coupled in operating condition-3.

FIG. 5 is a schematic view of an embodiment of the anchoring apparatus of the invention.

### DETAILED DESCRIPTION OF THE PREFERRED EMBODIMENT

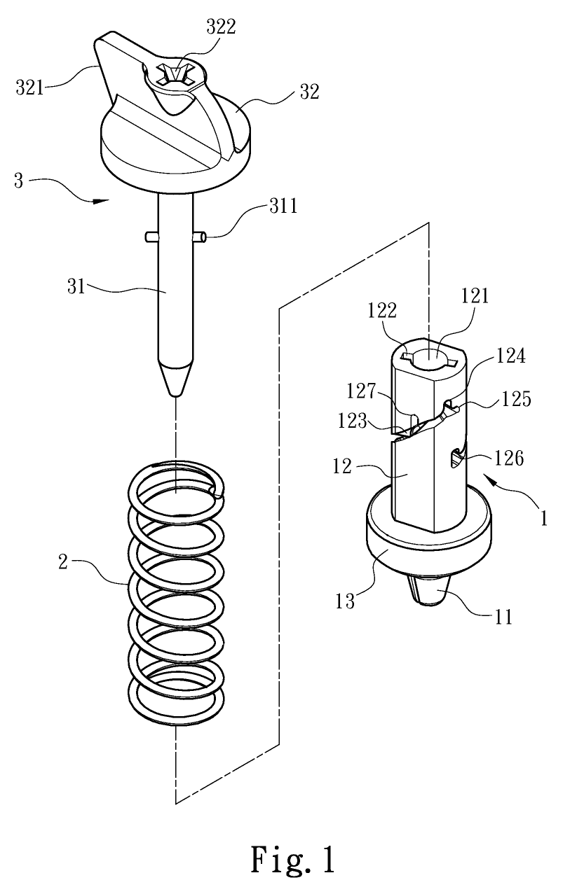

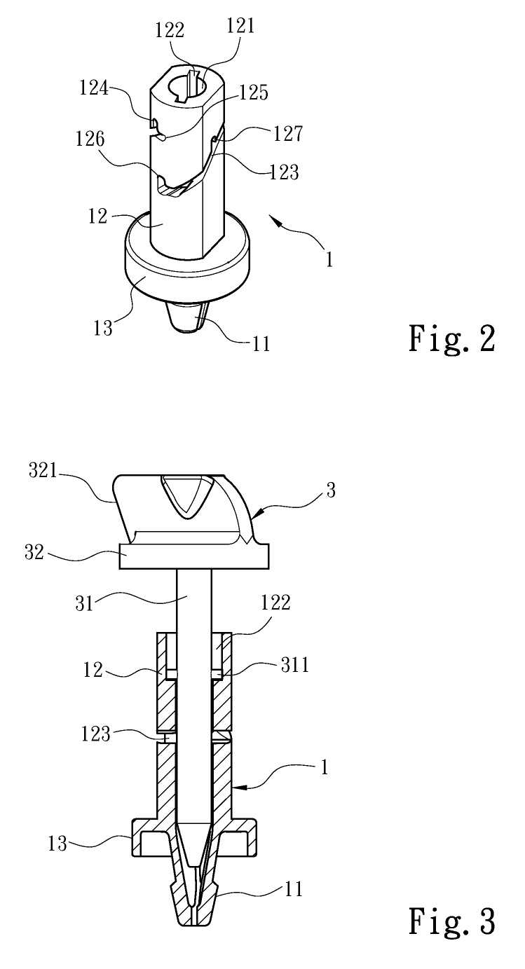

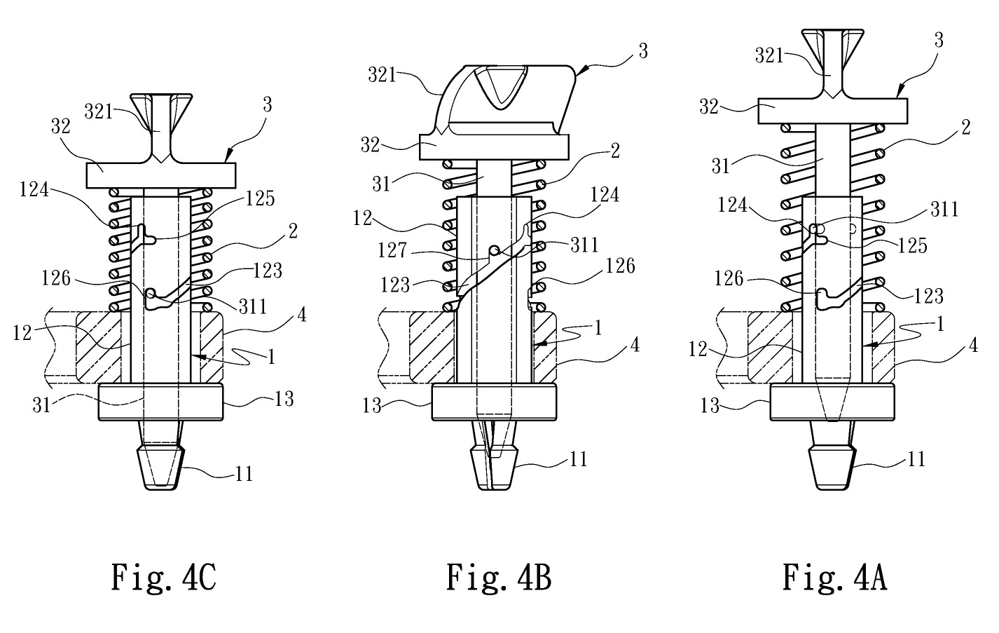

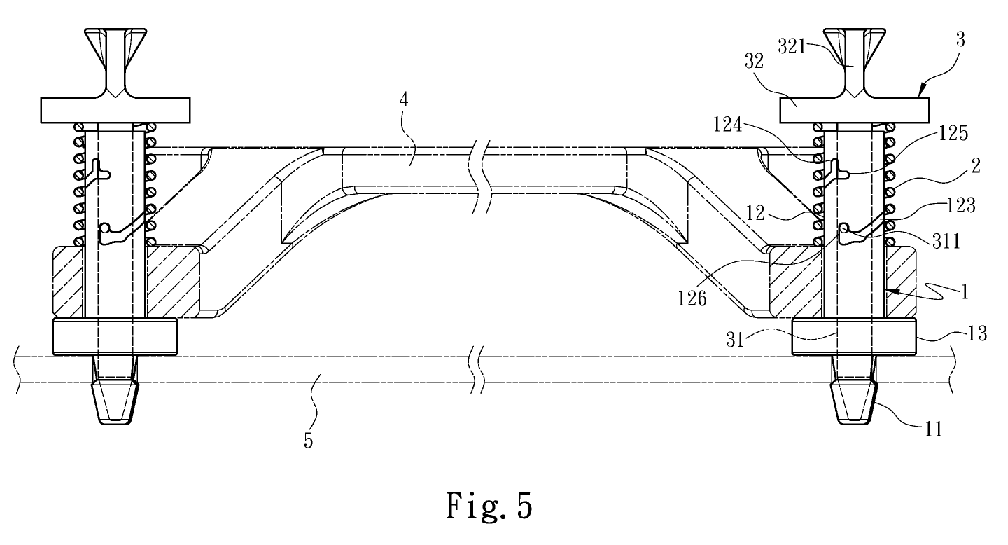

Please refer to FIGS. 1, 2 and 5 for an embodiment of the invention. The present invention provides a heat sink anchoring apparatus to position a heat sink equipped with an anchoring leg 4 (also referring to FIGS. 4A, 4B, 4C and 5) onto a baseboard 5 (referring to FIG. 5). The anchoring apparatus includes a bushing 1, an elastic element 2 and an insertion rod 3. The bushing 1 has a position end 11 and a sleeve 12 to couple with the anchoring leg 4 at an outer edge. The position end 11 is latched on the baseboard 5 (referring to FIG. 5) to hold the bushing 1 on the baseboard 5 in an upright manner. The facilitate latching on the baseboard 5 without loosening off, the position end 11 can be a conical member latchable on the baseboard 5. After the bushing 1 is anchored on the baseboard 5, the anchoring leg 4 is coupled with the sleeve 12 at the outside edge. The position end 11 and sleeve 12 are interposed by a jutting ring 13 of the anchoring leg 4 to facilitate firm standing of the bushing 1 on the baseboard 5. The sleeve 12 has an axle hole 121 inside extended towards the position end 11, an opening of the axle hole 121 is located at a front edge of the sleeve 12, and at least one track 123 formed on an inner edge of the axle hole 121. In the embodiment shown in FIG. 1, the sleeve 12 has two tracks 123 symmetrically located at two sides of the sleeve 12 and run through the sleeve 12 from the inner edge to outer edge. Each track 123 has two ends formed respectively a retaining notch 124 and 126. Aside from at the two ends of the track 123, one or more retaining notches 127 are formed between the two ends of the track 123 to provide multi-stage adjustment positions of the insertion rod 3. The elastic element 2 and the anchoring leg 4 are coaxially coupled outside the sleeve 12. In actual assembly, the elastic element 2 can be located above or below the anchoring leg 4. There is no restriction on the relative positions of the elastic element 2 and the anchoring leg 4. The elastic element 2 aims to provide a retaining elastic force for positioning the anchoring leg 4. Details will be discussed later. The insertion rod 3 is coupled with the sleeve 12 after coupling of the elastic element 2 and the sleeve 12 has been finished. The insertion rod 3 has a stem 31 and a force applying portion 32. The stem 31 has at least one sliding portion 311 on the outer edge. The sliding portion 311 is movable in the track 123. The number of the sliding portion 311 mates the number of the track 123. To enable the sliding portions 311 to wedge in the tracks 123, guiding tracks 122 are formed between the opening of the axle hole 121 and tracks 123 at a number mating the number of the sliding portions 311. There is an entering port 125 communicating the guiding track 122 and the tracks 123 to allow the sliding portion 311 to enter or escape from the tracks 123.

Referring to FIGS. 4A, 4B and 4C, for assembly, first, anchor the position end 11 of the bushing 1 on the baseboard 5 (referring to FIG. 5); couple the anchoring leg 4 and the elastic element 2 coaxially on the sleeve 12, insert the stem 31 into the axle hole 121 with the sliding portion 311 moved into the track 123; and apply a compression force on the force applying portion 32 to move the sliding portion 311 along the track 123. The force applying portion 32 can be a jutting rib 321 or a wedge cavity 322 turnable by a tool. In the embodiment shown in FIG. 1, the force applying portion 32 has the jutting rib 321 and wedge cavity 322. Then a selected force can be applied to the insertion rod 3 according to actual requirement. When the force applying portion 32 is compressed, the sliding portion 311 slides along the track 123, and the elastic element 4 is compressed to form a retaining elastic force to press the anchoring leg 4. The sliding portion 311 can slide and latch in the retaining notch 126 to form a latch and position condition. Thus the elastic element 2 provides a compression force on the anchoring leg 4 to form a firm positioning. Moreover, with other retaining notches 127 between the two ends of the track 123, the sliding portion 311 can be anchored in the retaining notches 127 at varying locations to change the pressure applying on the elastic element 2 in a multi-stage fashion. As shown in FIG. 5, with the position end 11 latched on the baseboard 5 and the anchoring leg 4 of the heat sink coupled outside the bushing 1, the anchoring leg 4 is compressed by the elastic element 2 from above, and the insertion rod 3 can be moved downwards, and through the elastic element 2 a compression force is applied to the anchoring leg 4. Thus a fast assembling and disassembling of the heat sink can be accomplished. By changing the latch position of the insertion rod 3 in the bushing 1, the compression force can be changed. Hence it is adaptable to varying specifications of the heat sinks.

The structure previously discussed can be assembled, anchored and disassembled quickly. With the sliding portion 311 and the retaining notches 124, 126 and 127, multi-stage adjustment of the pressure of the insertion rod 3 to the elastic element 2 can be provided. Hence the compression force can be adjusted as desired. The track 123 can be formed axially or helically on the sleeve 12 relative to the axial hole 121 to mate the movement of the insertion rod 3 and the sliding portion 311. Moreover, the outer edge of the sleeve 12 has at least one plane surface (as shown in FIG. 1) to confine the position of the anchoring leg 4 coupling outside the sleeve 12. The structure set forth above can adjust the retaining elastic force, and provide fast anchoring and disassembling in a simpler structure. It offers a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A heat sink anchoring apparatus to anchor a heat sink equipped with an anchoring leg on a baseboard, comprising:
a bushing which has an position end latched on the baseboard and a sleeve coupled on the anchoring leg at an outer edge thereof, the sleeve having an axle hole extended towards the position end and at least one track formed on an inner edge of the axle hole that has a retaining notch;
an elastic element coupled on the sleeve from an outer edge of the sleeve coaxial with the anchoring leg; and
an insertion rod which is held in the axle hole and has at least one sliding portion in the track and a force applying portion at the other end to compress the elastic element to form a retaining elastic force to press the anchoring leg and move the sliding portion along the track to the retaining notch to be anchored so that the anchoring leg is firmly positioned on the baseboard.

2. The heat sink anchoring apparatus of claim 1, wherein the retaining notch is located at two ends of the track.

3. The heat sink anchoring apparatus of claim 2, wherein at least one retaining notch is additionally located between the two ends of the track to provide multi-stage adjustment of the compression force for the insertion rod on the elastic element.

4. The heat sink anchoring apparatus of claim 1, wherein the track is formed axially with the axle hole and helically about the axle hole.

5. The heat sink anchoring apparatus of claim 4, wherein track runs through from the inner edge of the sleeve to the outer edge thereof.

6. The heat sink anchoring apparatus of claim 4 further having guiding tracks formed from an opening of the axle hole in a number mating the sliding portion to communicate with the track and allow the sliding portion to enter or escape from the track.

7. The heat sink anchoring apparatus of claim 1, wherein the force applying portion has a jutting rib to receive an external force.

8. The heat sink anchoring apparatus of claim 1, wherein the force applying portion has a wedge cavity turnable by a tool.

9. The heat sink anchoring apparatus of claim 1, wherein the force applying portion has a jutting rib to receive an external force and a wedge cavity turnable by a tool.

10. The heat sink anchoring apparatus of claim 1, wherein the position end is a conical element latchable on the baseboard.

11. The heat sink anchoring apparatus of claim 1, wherein the sleeve has at least one plane surface on the periphery to confine the position of the heat sink outside the sleeve.

12. The heat sink anchoring apparatus of claim 1 further having a jutting ring between the position end and the sleeve to support the anchoring leg.
